(19) United States
(12) Patent Application Publication
(10) Pub. No.: US 2015/0205896 A1
(43) Pub. Date: Jul. 23, 2015

(54) INFORMATION PROCESSING DEVICE, METHOD AND PROGRAM

(71) Applicants: KABUSHIKI KAISHA TOYOTA CHUO KENKYUSHO, Nagakute-shi, Aichi (JP); UNIVERSITY OF THE RYUKYUS, Nakagami-gun, Okinawa (JP)

(72) Inventors: Masato Tanaka, Kawasaki-shi (JP); Ryuji Omote, Owariasahi-shi (JP); Takashi Sasagawa, Nagakute-shi (JP); Masaki Fujikawa, Nakagami-gun (JP)

(73) Assignee: UNIVERSITY OF THE RYUKYUS, Nakahami-gun, Okinawa (JP)

(21) Appl. No.: 14/426,080

(22) PCT Filed: Sep. 6, 2013
(86) PCT No.: PCT/JP2013/074782

§ 371 Date: Mar. 4, 2015

(30) Foreign Application Priority Data
Sep. 7, 2012 (JP) 2012-197851

(51) Int. Cl. G06F 17/50; G06F 17/10

(52) U.S. Cl. CPC G06F 17/5018; G06F 17/10

(57) ABSTRACT

For each (ij)-th tensor component, an equation ΔF₁^{(ij)} using ε₁ is computed based on a function W(F) of an inputted tensor amount F and a value (F=F̂) of F. For each (kl)-th tensor component, an equation ^{˜}ΔF₂^{(kl)} using ε₁ and ε₂ is computed based on the value (F=F̂) of F. For each combination of an (ij)-th and a (kl)-th component, a function W(F̂+ΔF₁^{(ij)}+^{˜}ΔF₂^{(kl)}) is computed using the computed equations ΔF₁^{(ij)} and ^{˜}ΔF₂^{(kl)}. For each (ij)-th component, a coefficient of ε₁ in the function W(F̂+ΔF₁^{(ij)}+^{˜}ΔF₂^{(kl)}) is removed, and stress, based on a first order derivative with respect to the amount F of the function W(F), is computed. For each combination of an (ij)-th and a (kl)-th component, a coefficient of ε₁·ε₂ in the function W(F̂+ΔF₁^{(ij)}+^{˜}ΔF₂^{(kl)}) is removed, and a material Jacobian, based on a second order derivative with respect to the amount F of the function W(F), is computed.

### TECHNICAL FIELD

The present invention relates to an information processing device, method and program, and in particular, relates to an information processing device and program that carry out derivative calculation processing of a function.

### BACKGROUND ART

Numerous high-performance, all-purpose, finite element method (hereinafter abbreviated as FEM) analytic software have become commercially available in recent years. The efficient advancement of design work utilizing these all-purpose software is being carried out quite typically at manufacturing sites. However, it is often the case that, in the analytic work that a user has, special analytic techniques that exceed the range of functions of these all-purpose software are needed.

In order to address such a problem, many all-purpose FEM analytic software provide a user subroutine function so that the user himself can carry out customization and implement his own analytic techniques and models into the all-purpose software. Usually, in a user subroutine of a material constitutive model in all-purpose FEM software, in order to implement the desired material constitutive model, there is the need to compute a stress-strain matrix (called a material Jacobian), that is needed at the time of determining the stress value and tangent stiffness, for the provided displacement/strain amount, and return the computed matrix to the main program. The tangent stiffness and the material Jacobian are necessary for Newton-Raphson iterative method, and values that are fundamentally consistent with the stress increment algorithm must be returned.

In particular, in cases in which it is desired to take large time increment, and in cases of application to problems in which the non-linearity is strong such as the problem of material non-linearity or the problem of large deformation, and the like, correct computed values of the consistent tangent stiffness and the material Jacobian are essential. Moreover, the consistent tangent stiffness is important not only to the quadratic convergence of the Newton-Raphson method, but also in order to obtain the correct sensitivity and buckling eigenvalue. However, the more complex the material constitutive model, the more difficult the analytic derivation is, and, if even a part of the computation is incorrect, there are cases in which the solution diverges in the worst case. Therefore, meticulous attention must be paid to the computation. Further, depending on the material constitutive model, cases in which deriving itself is impossible in reality are not infrequent.

The material Jacobian is obtained by differentiating the stress by the strain. In order to omit derivation of the complex analytic solution of the material Jacobian, numerical differentiation using the forward Euler method of following equation (1) is utilized (Miehe, C, “Numerical Computation of algorithmic (consistent) tangent moduli in large-strain computational inelasticity”, Computer Methods in Applied Mechanics and Engineering, Vol. 134 (1996), pp. 223-240, and Sun, W., Chaikof, E. L. and Levenston, M. E., “Numerical approximation of tangent moduli for finite element implementations of nonlinear hyperelastic material models”, Journal of Biomechanical Engineering, Vol. 130, No. 6 (2008), pp. 061003).

$${f}^{′} ( x ) \approx \frac{f ( x + Δ x ) - f ( x )}{Δ x} \qquad ( 1 )$$

Here, f(x) is the scalar function, f′(x) is the first order derivative of the function f(x), and Δx is a small perturbation value.

On the other hand, Lai, K. L. and Crassidis, J. L., Extensions of the first and second complex-step derivative approximations, Journal of Computational and Applied Mathematics, Vol. 219 (2008), pp. 276-293 proposes the complex-step derivative approximation of following equation (2) as a numerical differentiation method without roundoff errors, and reports the excellent results thereof.

$${f}^{′} ( x ) \approx \frac{Im f ( x + iΔ x )}{Δ x} \qquad ( 2 )$$

Here, i is an imaginary number unit, and Im is an operator that takes the imaginary part. By extending the deriving operation to the complex plane, the complex-step derivative approximation method has innovative performance of not ever bringing about a roundoff error no matter how small of a perturbation value Ax is provided in regard to the first order derivative approximation. If the complex-step derivative approximation method is used, it is possible to set a perturbation value Δx that is independent of the problem, and all-purpose, highly-accurate derivative approximation is obtained. In Tanaka, Masato and Fujikawa, Masaki, “Numerical Approximation of Consistent Tangent Moduli Using Complex-Step Derivative and Its Application to Finite Deformation Problems”, Transactions of the Japan Society of Mechanical Engineers Series A, Vol. 77, No. 733 (2011), pp. 27-38, the methods of the aforementioned Miche, C., “Numerical Computation of algorithmic (consistent) tangent moduli in large-strain computational inelasticity”, Computer Methods in Applied Mechanics and Engineering, Vol. 134 (1996), pp. 223-240, and Sun, W., Chaikof, E. L. and Levenston, M. E., “Numerical approximation of tangent modulus for finite element implementations of nonlinear hyperelastic material models”, Journal of Biomechanical Engineering, Vol. 130, No. 6 (2008), pp. 0610063, are extended by using this complex-step derivative approximation method, and a highly-accurate numerical approximation method of the consistent tangent stiffness is derived.

### DISCLOSURE OF INVENTION

### Technical Problem

The approximation accuracy of the material Jacobian that is computed in accordance with the methods put forth in the aforementioned Miche, C., “Numerical Computation of algorithmic (consistent) tangent moduli in large-strain computational inelasticity”, Computer Methods in Applied Mechanics and Engineering, Vol. 134 (1996), pp. 223-240, and Sun, W., Chaikof, E. L. and Levenston, M. E., “Numerical approximation of tangent modulus for finite element implementations of nonlinear hyperelastic material models”, Journal of Biomechanical Engineering, Vol. 130, No. 6 (2008), pp. 0610063, depends on the magnitude of the perturbation value Δx that is used in the numerical differentiation. If the perturbation value Δx is too large, a truncation error arises, and, if the perturbation value Δx is too small, a roundoff error arises. The optimal magnitude of the perturbation value ΔAx must be determined while assessing the trade-off between the truncation error and the roundoff error. However, the optimal value of Δx depends on the absolute values of the material parameters, the geometric data and the like, and it is difficult to obtain a definitive guideline. In actuality, the current situation is that the optimal value of Δx can only be evaluated empirically. For this reason, the value of Δx is often called the “magic number”.

In principle, only first order derivative calculus can handle the complex-step derivative approximation method put forth in Tanaka, Masato and Fujikawa, Masaki, “Numerical Approximation of Consistent Tangent Moduli Using Complex-Step Derivative and Its Application to Finite Deformation Problems”, Transactions of the Japan Society of Mechanical Engineers Series A, Vol. 77, No. 733 (2011), pp. 27-38. In derivative calculus of orders higher than that, a roundoff error arises in the same way as in the forward Euler method. Considering cases in which a typical user implements a new constitutive model, it is desirable to be able to simultaneously determine both the stress and the material Jacobian from an energy function expression. Namely, a first order and second order derivative approximation method that does not have a roundoff error, and a technique that can highly-efficiently apply this to the deriving of the stress and the material Jacobian, are desired, but such a method does not exist in the conventional art.

The present invention has been made in consideration of the above-described circumstances.

### Solution to Problem

An information processing device relating to a first aspect is an information processing device that determines a directional derivative of a scalar valued function with respect to a tensor by using two numbers ε₁, ε₂ that are imaginary units and each of which squared is 0 and that are defined as numbers that are able to replace one another with regard to multiplication, the information processing device comprising: a first perturbation computing section that, for each (ij)-th component of a tensor, computes an equation that is denoted by ΔF₁^{(ij)} and that uses ε₁, on the basis of a function W(F) of a tensor amount F and a value (F=F̂) of the tensor amount F that are inputted; a second perturbation computing section that, for each (kl)-th component of a tensor, computes an equation that is denoted by ^{˜}ΔF₂^{(kl)} and that uses ε₁ and ε₂, on the basis of the value (F=F̂) of the tensor amount F; a function computing section that, for each combination of an (ij)-th component and a (kl)-th component of a tensor, computes a function W(F̂+ΔF₁^{(ij)}+^{˜}ΔF₂^{(kl)}) by using the computed equation that is denoted by ΔF₁^{(ij)} and the computed equation that is denoted by ^{˜}ΔF₂^{(kl)}; a first physical quantity computing section that, for each (ij)-th component of a tensor, takes-out a coefficient of ε₁ in the function W(F̂+ΔF₁^{(ij)}+^{˜}ΔF₂^{(kl)}) that was computed by the function computing section, and computes a first physical quantity that is based on a first order derivative with respect to the tensor amount F of the function W(F); and a second physical quantity computing section that, for each combination of an (ij)-th component and a (kl)-th component of a tensor, takes-out a coefficient of ε₁·ε₂ in the function W(F̂+ΔF₁^{(ij)}+^{˜}ΔF₂^{(kl)})) that was computed by the function computing section, and computes a second physical quantity that is based on a second order derivative with respect to the tensor amount F of the function W(F), wherein the equation denoted by ΔF₁^{(ij)} is determined in advance such that the coefficient of ε₁ in the function W(F̂+ΔF₁^{(ij)}+^{˜}ΔF₂^{(kl)}) becomes the first physical quantity, and the equation denoted by ^{˜}ΔF₂^{(kl)} is determined in advance such that the coefficient of ε₁·ε₂ in the function W(F̂+ΔF₁^{(ij)}+^{˜}ΔF₂^{(kl)}) becomes the second physical quantity.

A program relating to a second aspect is a program for determining a directional derivative of a scalar valued function with respect to a tensor by using two numbers ε₁, ε₂ that are imaginary units and each of which squared is 0 and that are defined as numbers that are able to replace one another with regard to multiplication, the program causing a computer to function as: a first perturbation computing section that, for each (ij)-th component of a tensor, computes an equation that is denoted by ΔF₁^{(ij)} and that uses ε₁, on the basis of a function W(F) of a tensor amount F and a value (F=F̂) of the tensor amount F that are inputted; a second perturbation computing section that, for each (kl)-th component of a tensor, computes an equation that is denoted by ^{˜}ΔF₂^{(kl)} and that uses ε₁ and ε₂, on the basis of the value (F=F̂) of the tensor amount F; a function computing section that, for each combination of an (ij)-th component and a (kl)-th component of a tensor, computes a function W(F̂+ΔF₁^{(ij)}+^{˜}ΔF₂^{(kl)}) by using the computed equation that is denoted by ΔF₁^{(ij)} and the computed equation that is denoted by ^{˜}ΔF₂^{(kl)}; a first physical quantity computing section that, for each (ij)-th component of a tensor, takes-out a coefficient of ε₁ in the function W(F̂+ΔF₁^{(ij)}+^{˜}ΔF₂^{(kl)}) that was computed by the function computing section, and computes a first physical quantity that is based on a first order derivative with respect to the tensor amount F of the function W(F); and a second physical quantity computing section that, for each combination of an (ij)-th component and a (kl)-th component of a tensor, takes-out a coefficient of ε₁·ε₂ in the function W(F̂+ΔF₁^{(ij)}+^{˜}ΔF₂^{(kl)})) that was computed by the function computing section, and computes a second physical quantity that is based on a second order derivative with respect to the tensor amount F of the function W(F), wherein the equation denoted by ΔF₁^{(ij)} is determined in advance such that the coefficient of ε₁ in the function W(F̂+ΔF₁^{(ij)}+^{˜}ΔF₂^{(kl)}) becomes the first physical quantity, and the equation denoted by ^{˜}ΔF₂^{(kl)} is determined in advance such that the coefficient of ε₁·ε₂ in the function W(F̂+ΔF₁^{(ij)}+^{˜}ΔF₂^{(kl)}) becomes the second physical quantity.

In accordance with the first aspect and the second aspect, an equation that is denoted by ΔF₁^{(ij)} and that uses ε₁ is computed by the first perturbation computing section, for each (ij)-th component of a tensor, on the basis of a function W(F) of a tensor amount F and a value (F=F̂) of the tensor amount F that are inputted. An equation that is denoted by ^{˜}ΔF₂^{(kl)} and that uses ε₁ and ε₂ is computed by the second perturbation computing section, for each (kl)-th component of a tensor, on the basis of the value (F=F̂) of the tensor amount F.

Further, a function W(F̂+ΔF₁^{(ij)}+^{˜}ΔF₂^{(kl)}) is computed by the function computing section for each combination of an (ij)-th component and a (kl)-th component of a tensor, by using the computed equation that is denoted by ΔF₁^{(ij)} and the computed equation that is denoted by ^{˜}ΔF₂^{(kl)}. By the first physical quantity computing section and for each (ij)-th component of a tensor, a coefficient of ε₁ in the function W(F̂+ΔF₁^{(ij)}+^{˜}ΔF₂^{(kl)}) that was computed by the function computing section is taken-out, and a first physical quantity, that is based on a first order derivative with respect to the tensor amount F of the function W(F), is computed. By the second physical quantity computing section and for each combination of an (ij)-th component and a (kl)-th component of a tensor, a coefficient of ε₁·ε₂ in the function W(F̂+ΔF₁^{(ij)}+^{˜}ΔF₂^{(kl)}) that was computed by the function computing section is taken-out, and a second physical quantity, that is based on a second order derivative with respect to the tensor amount F of the function W(F), is computed.

In this way, by taking-out the coefficient of ε₁ in the function W(F̂+ΔF₁^{(ij)}+^{˜}ΔF₂^{(kl)}) and computing a first physical quantity that is based on a first order derivative with respect to the tensor amount F of a function W(F), and taking-out the coefficient of ε₁·ε₂ in the function W(F̂+ΔF₁^{(ij)}+^{˜}ΔF₂^{(kl)}) and computing a second physical quantity that is based on a second order derivative with respect to the tensor amount F of the function W(F), a physical quantity that is based on the first order derivative of a function, and a physical quantity that is based on the second order derivative, can be computed while suppressing the occurrence of errors.

A third aspect can be made such that the function is a function relating to an object of simulation, the first physical quantity computing section computes the first physical quantity that is to be used in simulation, and the second physical quantity computing section computes the second physical quantity that is to be used in simulation.

An information processing device relating to a fourth aspect can be made to further comprise a simulation section that carries out simulation using a finite element method (FEM), wherein the inputted tensor amount is a deformation gradient tensor that expresses strain, the simulation is a simulation relating to behavior of a material, the first physical quantity computing section computes a stress tensor as the first physical quantity, the second physical quantity computing section computes a material Jacobian as the second physical quantity, and the simulation section carries out simulation by using the stress tensor computed by the first physical quantity computing section and the material Jacobian computed by the second physical quantity computing section.

### Advantageous Effects of Invention

As described above, in accordance with the information processing device and program of the present invention, the effect is obtained that the first order derivative value and the second order derivative value of a function can be computed while suppressing the occurrence of errors.

### BRIEF DESCRIPTION OF DRAWINGS

FIG. 1 is a block diagram showing an information processing device relating to a first reference example.

FIG. 2 is a flowchart showing the contents of a derivative calculation processing routine of the information processing device relating to the first reference example.

FIG. 3 is a flowchart showing the contents of a simulation processing routine of an information processing device relating to a first embodiment of the present invention.

FIG. 4 is a flowchart showing the contents of a processing routine of processing for incorporating an energy function into FEM computation, in accordance with the information processing device relating to the first embodiment of the present invention.

### BEST MODES FOR CARRYING OUT THE INVENTION

Embodiments of the present invention are described hereinafter in detail with reference to the drawings.

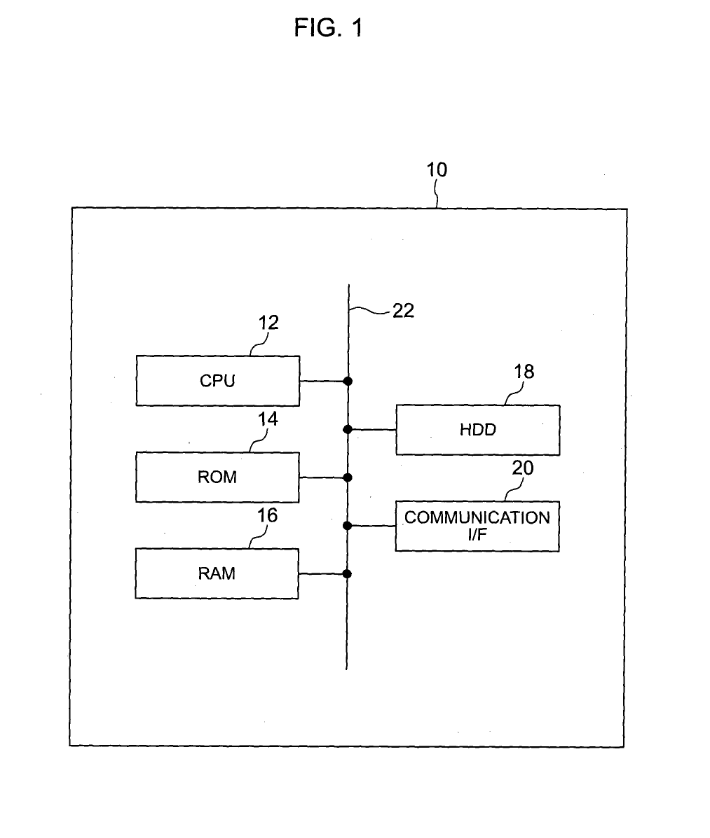

As shown in FIG. 1, an information processing device 10 relating to a first reference example has a CPU 12, a ROM 14, a RAM 16, an HDD 18, a communication interface 20, and a bus 22 that is for connecting these to one another.

The CPU 12 executes various programs. Various programs and parameters and the like are stored in the ROM 14. The RAM 16 is used as a work area or the like at the time of execution of various programs by the CPU 12. Various programs, that include a program for executing a derivative calculation processing routine that is described later, and various data are stored in the HDD 18 that serves as a storage medium.

In the derivative calculation processing method by the information processing device 10 in the first reference example, the first order derivative value and the second order derivative value of a function of one variable are computed by using multi dual numbers that are described hereinafter.

Here, the principles of derivative calculation using multi dual numbers are described.

First, multi dual numbers are defined as follows.

Multi dual numbers are a variety of complex numbers, and have two types of imaginary number units that are ε₁, ε₂, and have the following property.

ε₁²=0, ε₂²=0, ε₁ε₂=ε₂ε₁

Namely, each of the imaginary number units squared is 0, and the two types of imaginary number units can replace one another with regard to multiplication. For these multi dual numbers, in the same way as a usual complex number, the definitions of the four basic arithmetic operations and elementary functions can be extended naturally. Representative computational examples of the multi dual numbers are given hereinafter, (aᵢ, bᵢ (i=1, 2, 3, 4) are all real numbers.)

sum

(a₁+a₂ε₁+a₃ε₂+a₄ε₁ε₂)+(b₁+b₂ε₁+b₃ε₂+b₄ε₁ε₂) =(a₁+b₁)+(a₂+b₂)ε₁+(a₃+b₃)ε₂+(a₄+b₄)ε₁ε₂

multiplication

(a₁+a₂ε₁+a₃ε₂ +a₄ε₁ε₂)·(b₁+b₂ε₁+b₃ε₂+b₄ε₁ε₂) =(a₁b₁)+(a₁b₂+a₂b₁)ε₁+(a₁b₃+a₃b₁)ε₂+(a₁b₄+a₄b₁+a₂b₃+a₃b₂)ε₁ε₂

When the multi dual numbers that have the above operational rules are substituted for small perturbation value Δx of the Taylor expansion equation for the function f(x) shown by following equation (3), following equation (4) is obtained.

$$\begin{matrix}( before substitution ) \\ f ( x + Δ x ) = f ( x ) + Δ {xf}^{ ′} ( x ) + \frac{{( Δ x )}^{2}}{2 !} {f}^{″} ( x ) + \frac{{( Δ x )}^{3}}{3 !} {f}^{′′′} ( x ) + … & ( 3 ) \\ ( after substitution ) \\ \begin{matrix}f ( x + {ɛ}_{1} + {ɛ}_{2} ) = f ( x ) + ( {ɛ}_{1} + {ɛ}_{2} ) {f}^{′} ( x ) + \\ \frac{{( {ɛ}_{1} + {ɛ}_{2} )}^{2}}{2 !} {f}^{″} ( x ) + \frac{{( {ɛ}_{1} + {ɛ}_{2} )}^{3}}{3 !} {f}^{′′′} ( x ) … \\ = f ( x ) + ( {ɛ}_{1} + {ɛ}_{2} ) {f}^{′} ( x ) + {ɛ}_{1} {ɛ}_{2} {f}^{″} ( x )\end{matrix} & ( 4 )\end{matrix}$$

Namely, when it is desired to compute the derivative value at x=a of the function f(x), first, x=a+ε₁+ε₂ is substituted into the function f(x), and the function computation is replaced into the multi dual numbers by rote. If the coefficient of ε₁ or ε₂ is taken-out from the results of computation thereof, the first order derivative value f′(a) is automatically obtained, and if the coefficient of ε₁ε₂, is taken-out, the second order derivative value f′(a) is automatically obtained.

Operation at the time of carrying out derivative calculation by the information processing device 10 relating to the first reference example is described next.

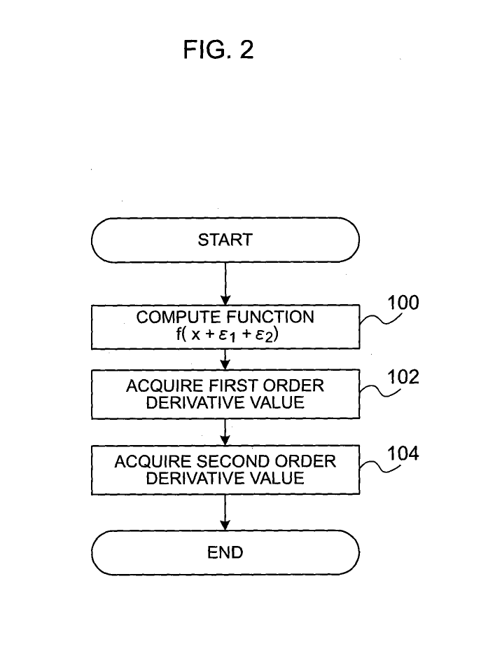

First, when the function f(x) and the value a of variable x at the time of computing the derivative value are inputted to the information processing device 10, the derivative calculation processing routine shown in FIG. 2 is executed by the information processing device 10.

First, in step 100, the information processing device 10 substitutes x=a+ε₁+ε₂ into the inputted function f(x), and computes function f(a+ε₁+ε₂).

Next, in step 102, the information processing device 10 takes-out the coefficient of ε₁ or ε₂ from the results of computation of above step 100, and outputs the first order derivative value f′(a). Further, in step 104, the information processing device takes-out the coefficient of ε₁·ε₂ from the results of computation of above step 100, and outputs the second order derivative value f″(a), and ends the derivative calculation processing routine.

As described above, in accordance with the information processing device relating to the first reference example, by using the multi dual numbers, the function f(a+ε₁+ε₂) is computed, and the coefficient of ε₁ or ε₂ in the function f(a+ε₁+ε₂) is taken-out as the first order derivative value f′(a) at the time of differentiating the function by a scalar amount, and the coefficient of ε₁·ε₂ in the function f(a+ε₁+ε₂) is taken-out as the second order derivative value f″(a). Due thereto, the information processing device can compute the first order derivative value and the second order derivative value of the function while suppressing the occurrence of errors.

Note that, although the above-described reference example explains the definition of the four basic arithmetic operations, computation of an elementary function using the multi dual numbers as the arguments also is possible. Several examples of computation of elementary functions in accordance with the multi dual numbers are shown hereinafter.

$$sin ( {a}_{1} + {a}_{2} {ɛ}_{1} + {a}_{3} {ɛ}_{2} + {a}_{4} {ɛ}_{1} {ɛ}_{2} ) = sin {a}_{1} + {a}_{2} cos {a}_{1} {ɛ}_{1} + {a}_{3} cos {a}_{1} {ɛ}_{2} + ( {a}_{4} cos {a}_{1} - {a}_{2} {a}_{3} sin {a}_{1} ) {ɛ}_{1} {ɛ}_{2}$$

$$exp ( {a}_{1} + {a}_{2} {ɛ}_{1} + {a}_{3} {ɛ}_{2} + {a}_{4} {ɛ}_{1} {ɛ}_{2} ) = exp ( {a}_{1} ) + {a}_{2} exp ( {a}_{1} ) {ɛ}_{1} + {a}_{3} exp ( {a}_{1} ) {ɛ}_{2} + ( {a}_{4} + {a}_{2} {a}_{3} ) exp ( {a}_{1} ) {ɛ}_{1} {ɛ}_{2}$$

$$log ( {a}_{1} + {a}_{2} {ɛ}_{1} + {a}_{3} {ɛ}_{2} + {a}_{4} {ɛ}_{1} {ɛ}_{2} ) = log {a}_{1} + \frac{{a}_{2}}{{a}_{1}} {ɛ}_{1} + \frac{{a}_{3}}{{a}_{1}} {ɛ}_{2} + ( \frac{{a}_{4}}{{a}_{1}} - \frac{{a}_{2} {a}_{3}}{{a}_{1}^{2}} ) {ɛ}_{1} {ɛ}_{2}$$

A second reference example is described next. Note that, because the information processing device relating to the second reference example has a similar structure as the first reference example, the same reference numerals are used and description is omitted.

In the second reference example, the point that the partial derivative values of a function of two variables is computed is different than the first reference example.

The partial derivative values of a function of two variables can be extended naturally as follows, in the same way as a function of one variable. Namely, when ε₁ is substituted for small perturbation value Δx and ε₂ is substituted for small perturbation value Δy in the function of two variables shown in following equation (5), following equation (6) is obtained.

$$\begin{matrix}( before substitution ) \\ g ( x + Δ x , y + Δ y ) = g ( x , y ) + ( Δ x \frac{\partial }{\partial x} + Δ y \frac{\partial }{\partial y} ) g + \frac{1}{2 !} {( Δ x \frac{\partial }{\partial x} + Δ y \frac{\partial }{\partial y} )}^{2} g + … & ( 5 ) \\ ( after substitution ) \\ \begin{matrix}g ( x + {ɛ}_{1} , y + {ɛ}_{2} ) = g ( x , y ) + ( {ɛ}_{1} \frac{\partial }{\partial x} + {ɛ}_{2} \frac{\partial }{\partial y} ) g ( x , y ) + \\ \frac{1}{2 !} {( {ɛ}_{1} \frac{\partial }{\partial x} + {ɛ}_{2} \frac{\partial }{\partial y} )}^{2} g ( x , y ) + … \\ = g ( x , y ) + {ɛ}_{1} \frac{\partial g}{\partial x} ( x , y ) + \\ {ɛ}_{2} \frac{\partial x}{\partial y} ( x , y ) + {ɛ}_{1} {ɛ}_{2} \frac{{\partial }^{2} g}{\partial x \partial y} ( x , y )\end{matrix} & ( 6 )\end{matrix}$$

Here, when it is desired to compute the derivative value at x=a, y=b of function g(x,y), x=a+ε₁, y=b+ε₂ are substituted in function g(x,y) as well, and when the coefficient of ε₁ is taken-out from the computed results, the first order partial derivative value ∂g(a,b)/∂x is automatically obtained. Further, when the coefficient of ε₂ is taken-out from the computed results, the first order partial derivative value ∂g(a,b)/∂y is obtained, and when the coefficient of ε₁ε₂ is taken-out, the second order partial derivative value ∂²g(a,b)/δxδy is automatically obtained.

Operation at the time of carrying out derivative calculation in accordance with the information processing device relating to the second reference example is described next.

First, when the function g(x,y) and the values a, b of the variables x, y at the time of computing the partial derivative values are inputted to the information processing device 10, a derivative calculation processing routine that is similar to that of above-described FIG. 2 is executed by the information processing device 10.

First, the information processing device 10 substitutes x=a+ε₁, y=b+ε₂ into the inputted function g(x,y), and computes function g(a+ε₁,b+ε₂).

Further, the information processing device 10 takes-out the coefficient of ε₁ from the above results of computation, and outputs the first order partial derivative value ∂g(a,b)/∂x. Moreover, the information processing device 10 takes-out the coefficient of ε₂ from the above results of computation, and outputs the first order partial derivative value ∂g(a,b)/∂y. Further, the information processing device 10 takes-out the coefficient of ε₁·ε₂ from the above results of computation, and outputs the second order partial derivative value ∂²g(a,b)/∂x∂y, and ends the derivative calculation processing routine.

As described above, in accordance with the information processing device relating to the second reference example, by using the multi dual numbers, g(a+ε₁,b+ε₂) is computed, and the coefficient of ε₁ in the function g(a+ε₁,b+ε₂) is taken-out as the first order partial derivative value ∂g(a,b)/∂x, and the coefficient of ε₂ in the function g(a+ε₁,b+ε₂) is taken-out as the first order partial derivative value ∂g(a,b)/∂y, and the coefficient of ε₁·ε₂ in the function g(a+ε₁,b+ε₂) is taken-out as the second order partial derivative value ∂²g(a,b)/∂x∂y. Due thereto, the information processing device can compute the first order partial derivative values and the second order partial derivative value of the function while suppressing the occurrence of errors.

A first embodiment is described next. Note that, because the information processing device relating to the first embodiment has a similar structure as the first reference example, the same reference numerals are used and description is omitted.

The first embodiment differs from the first reference example with regard to the point that simulation using a FEM is carried out, and the point that the derivative value with respect to directional derivative of a tensor is computed.

In the derivative calculation method in accordance with the information processing device 10 in the first embodiment, a first order derivative value and a second order derivative value with respect to tensor directional derivative of an energy function are computed by using the multi dual numbers. Further, in the material simulation method in accordance with the information processing device 10, by using the first order derivative value and the second order derivative value that are computed by the aforementioned derivative calculation method, FEM computation is carried out, and the stress with respect to inputted strain (the tensor amount) is computed as the results of simulation.

The principles of automatic computation of stress and the material Jacobian, using the multi dual numbers, are described next.

A method of computing stress and the material Jacobian from an energy function is illustrated hereinafter. In a user subroutine of a material constitutive model in an FEM program that is an example of all-purpose software, deformation gradient tensor F is inputted as a “variables passed in for information”. By using F, the user implements a program that hands over the Cauchy stress σ and the respective components of the material Jacobian C^{∇MJ} (a fourth order tensor) that are computed from the energy function. Further, user subroutines of material constitutive models in all-purpose FEM software often employ formularization by the updated Lagrange method by using the Jaumann rate of the Kirchhoff stress τ in the material Jacobian. Here as well, description is given on the basis of this formularization. The definitional equations of the Kirchhoff stress τ, the Jaumann rate τ^{∇J} of τ, and the corresponding material Jacobian C^{∇MJ} are following equation (7) through equation (9) respectively.

τ=Jσ (7)

τ^{∇J}=τ\dot{t}−Wτ+τW (8)

τ^{∇J}=JC^{∇MJ}:D (9)

Here, “.” expresses the material time derivative and “:” expresses the contraction with respect to two sets of basis vectors of the tensor. Further, J is the volume change rate, and is expressed by following equation (10) by using the deformation gradient tensor F.

J=det F (10)

Further, D, W are the symmetrical component and the antisymmetrical component of the spatial velocity gradient tensor L of following equation (11).

L=\dot{F}F⁻¹ (11)

Here, T⁻¹ represents the inverse matrix of the tensor T.

The method of computing the stress is described next.

If the symmetry of τ is taken into consideration, the (ij)-th component τᵢⱼ of τ is expressed by following equation (12).

$${τ}_{ij} = \frac{1}{2} τ : ( {e}_{i} ⊗ {e}_{j} + {e}_{j} ⊗ {e}_{i} ) \qquad ( 12 )$$

Here, eᵢ is the unit basis vector in the Cartesian coordinate system, and [symbol] is the tensor product. First, the derivative with respect to F of W(F) (the directional derivative of the tensor) is considered. In order to simplify the process of deriving τ that is described later, the approximation equation shown by following equation (13) is obtained, given that the small increment amount of the deformation gradient tensor F is ΔF₁^{(ij)}.

$$W ( F + Δ {F}_{1}^{( ij )} ) = W ( F ) + \frac{\partial W}{\partial F} \text{:} Δ {F}_{1}^{( ij )} + \frac{1}{2 !} Δ {F}_{1}^{( ij )} \text{:} \frac{{\partial }^{2} W}{\partial F \partial F} : Δ {F}_{1}^{( ij )} + … \qquad ( 13 )$$

Here, the increment amount ΔF₁^{(ij)} is defined as per following equation (14) by using the imaginary unit ε₁ of the multi dual numbers.

$$Δ {F}_{1}^{( ij )} = \frac{{ɛ}_{1}}{2} ( {e}_{i} ⊗ {e}_{j} + {e}_{j} ⊗ {e}_{i} ) F \qquad ( 14 )$$

Next, by substituting above equation (14) into above equation (13) and arranging the right side, following equation (15) is obtained.

$$W ( F + Δ {F}_{1}^{( ij )} ) = W ( F ) + \frac{{ɛ}_{1}}{2} {F ( \frac{\partial W}{\partial F} )}^{T} \text{:} ( {e}_{i} ⊗ {e}_{j} + {e}_{j} ⊗ {e}_{i} ) \qquad ( 15 )$$

Here, T^{T} represents the transpose of the tensor T. The first Piola-Kirchhoff stress P shown by following equation (16) is included in the right side of above equation (15), and the relationship with τ is as per following equation (16).

$$\{ \begin{matrix}P = {( \frac{\partial W}{\partial F} )}^{T} \\ τ = FP\end{matrix} \qquad ( 16 )$$

Note that the stress τ is an example of a first physical quantity that is based on first order derivative with respect to the tensor amount F of the function W(F). Further, the material Jacobian is an example of a second physical quantity that is based on second order derivative with respect to the tensor amount F of the function W(F).

If above equation (15) is arranged by using above equation (12) and equation (16), following equation (17) that computes x from W(F) is obtained.

τᵢⱼ=ℑ₁[W(F+ΔF₁^{(ij)})] (17)

Here,

ℑ₁
is an operator that takes-out the coefficient of ε₁.

The method of computing the material Jacobian is described next.

A method of computing material Jacobian C^{∇MJ} from the energy function W(F) is shown. The method of computing the material Jacobian C^{∇MJ} from the Kirchhoff stress τ is as per following equation (18).

(C^{∇MJ})ᵢⱼₖₗ=ℑ₂[τᵢⱼ(F+ΔF₂^{(kl)})] (18)

Here,

ℑ₂
is an operator that takes-out the coefficient of ε₁, and ΔF₂^{(kl)} is defined as per following equation (19).

$$Δ {F}_{2}^{( kl )} = \frac{{ɛ}_{2}}{2} ( {e}_{k} ⊗ {e}_{l} + {e}_{l} ⊗ {e}_{k} ) \cdot F \qquad ( 19 )$$

When above equation (17) and equation (18) are combined, following equation (20) is obtained.

$${( {C}^{∇ MJ} )}_{ijkl} = \frac{1}{J} {}_{12} [ W ( F + Δ {F}_{1}^{( ij )} + Δ {\tilde{F}}_{2}^{( kl )} ) ] \qquad ( 20 )$$

Here,

ℑ₁₂
is an operator that takes-out the coefficient of ε₁ε₂, and ^{˜}ΔF₂^{(kl)} is defined as per following equation (21).

$$Δ {\tilde{F}}_{2}^{( kl )} = Δ {F}_{2}^{( kl )} + {ɛ}_{1} \frac{1}{2} ( {e}_{i} ⊗ {e}_{j} + {e}_{j} ⊗ {e}_{i} ) Δ {F}_{2}^{( kl )} \qquad ( 21 )$$

At this time, the stress is determined by following equation (22).

$${σ}_{ij} = \frac{1}{J} {}_{1} [ W ( F + Δ {F}_{1}^{( ij )} + Δ {\tilde{F}}_{2}^{( kl )} ) ] \qquad ( 22 )$$

Further, the method of determining the increment amounts ΔF₁^{(ij)} and ^{˜}ΔF₂^{(kl)} is described.

As shown hereafter, ΔF₁^{(ij)} is set so as to derive the Cauchy stress tensor σ, and ^{˜}ΔF₂^{(kl)} is set so as to derive the material Jacobian C^{∇MJ}.

The Cauchy stress tensor σ and the Kirchhoff stress tensor τ are related by above equation (7). Namely, if the Kirchhoff stress tensor τ can be determined, the Cauchy stress tensor σ can be determined directly by dividing the Kirchhoff stress tensor τ by J. Accordingly, the method of setting ΔF₁^{(ij)} that derives the Kirchhoff stress tensor τ from the energy function W(F) is shown hereinafter.

As shown by above equation (16), the relationship shown by following equation (23) exists between the energy function W(F) and the Kirchhoff stress tensor τ.

$$τ = {F ( \frac{\partial W}{\partial F} )}^{T} \qquad ( 23 )$$

Note that above equation (23) corresponds to a relational expression between the first physical quantity and the function W(X).

Considering the symmetry of τ, when the transposes of both sides of above equation (23) are taken, following equation (24) is obtained.

$$τ = ( \frac{\partial W}{\partial F} ) {F}^{T} \qquad ( 24 )$$

In the method of above equation (12), when the ij component τᵢⱼ of τ of above equation (24) is determined, following equation (25) results.

$${τ}_{ij} = ( \frac{\partial W}{\partial F} ) {F}^{T} \text{:} \frac{1}{2} ( {e}_{i} ⊗ {e}_{j} + {e}_{j} ⊗ {e}_{i} ) \qquad ( 25 )$$

Moreover, above equation (25) is transformed as per following equation (26).

$${τ}_{ij} ( \frac{\partial W}{\partial F} ) \text{:} \frac{1}{2} ( {e}_{i} ⊗ {e}_{j} + {e}_{j} ⊗ {e}_{i} ) F \qquad ( 26 )$$

The relationship between the directional derivative of the tensor and the derivative calculus method in accordance with the multi dual numbers is shown hereinafter. First, the definition of the directional derivative of the scalar value tensor function with respect to the tensor is shown. The scalar function that makes the tensor be an independent variable is called a “scalar value tensor function”. Here, considering scalar value tensor function G(A) (where G is a scalar and A is a second order tensor), differentiating this G by A in the direction of ΔA is expressed by following equation (27).

$$DG ( A ) [ Δ A ] = {lim}_{h -> 0} \frac{G ( A + h Δ A ) - G ( A )}{h} = \frac{\partial G ( A )}{\partial A} \text{:} Δ A \qquad ( 27 )$$

Here, symbol DG(A)[ΔA] represents the directional derivative, and ΔA is called a directional tensor. When the equation of the derivative of the second part of above equation (27) is rewritten by using the multi dual numbers, following equation (28) is obtained.

$${lim}_{h -> 0} \frac{G ( A + h Δ A ) - G ( A )}{h} = {𝒥}_{1} [ G ( A + {ɛ}_{1} Δ A ) ] \qquad ( 28 )$$

Following equation (29) is obtained from above equation (27) and equation (28).

$$DG ( A ) [ Δ A ] = {𝒥}_{1} [ G ( A + {ɛ}_{1} Δ A ) ] = \frac{\partial G ( A )}{\partial A} \text{:} Δ A \qquad ( 29 )$$

Above equation (27) through equation (29) correspond to the relationship between the directional derivative of the tensor and the derivative with respect to ε₁.

Comparing above equation (29) and above equation (26), when W is substituted for G, and F is substituted for A, and

$$\frac{1}{2} ( {e}_{i} ⊗ {e}_{j} + {e}_{j} ⊗ {e}_{i} ) F$$

is substituted for ΔA, it can be understood that τᵢⱼ is expressed by following equation (30).

$${τ}_{ij} = {𝒥}_{1} [ W ( F + {ɛ}_{1} \frac{1}{2} ( {e}_{i} ⊗ {e}_{j} + {e}_{j} ⊗ {e}_{i} ) F ) ] \qquad ( 30 )$$

Namely, it can be understood that, by setting

$$Δ {F}_{1}^{( ij )} = \frac{{ɛ}_{1}}{2} ( {e}_{i} ⊗ {e}_{j} + {e}_{j} ⊗ {e}_{i} ) F$$

τᵢⱼ is determined by above equation (17).

Next, the method of setting ^{˜}ΔF₂^{(kl)} for deriving the material Jacobian C^{∇MJ} is illustrated. C^{∇MJ} is defined as the relationship between τ∇J and D as per above equation (9). First, above equation (8) and equation (9) are made into increment forms as per following equation (31) and equation (32).

Δτ^{∇J}=Δτ−ΔWτ+τΔW (31)

Δτ^{∇J}=JC^{∇MJ}:ΔD (32)

Here, ΔD and ΔW are expressed by following equation (33) and equation (34), by using the increment form ΔF of the deformation gradient tensor.

$$\begin{matrix}Δ D = \frac{1}{2} ( Δ {FF}^{- 1} + {F}^{- T} Δ {F}^{T} ) & ( 33 ) \\ Δ W = \frac{1}{2} ( Δ {FF}^{- 1} - {F}^{- T} Δ {F}^{T} ) & ( 34 )\end{matrix}$$

Here, when

$$h \frac{1}{2} ( {e}_{k} ⊗ {e}_{l} + {e}_{l} ⊗ {e}_{k} ) F$$

is substituted for ΔF, following equation (35) through equation (38) are derived from above equation (31) and equation (32).

$$\begin{matrix}Δ D = h \frac{1}{2} ( {e}_{k} ⊗ {e}_{l} + {e}_{l} ⊗ {e}_{k} ) & ( 35 ) \\ Δ W = 0 & ( 36 ) \\ Δ τ = {JC}^{∇ MJ} \text{:} h \frac{1}{2} ( {e}_{k} ⊗ {e}_{l} + {e}_{l} ⊗ {e}_{k} ) & ( 37 ) \\ Δτ = τ ( F + h \frac{1}{2} ( {e}_{k} ⊗ {e}_{l} + {e}_{l} ⊗ {e}_{k} ) F ) - τ ( F ) & ( 38 )\end{matrix}$$

Note that above equation (37) corresponds to the relational expression between the increment of the first physical quantity and the second physical quantity.

From above equation (37) and equation (38), when taking the limit of h→0, following equation (39) is obtained.

$${lim}_{h -> 0} \frac{τ ( F + h \frac{1}{2} ( {e}_{k} ⊗ {e}_{l} + {e}_{l} ⊗ {e}_{k} ) F ) - τ ( F )}{h} = {JC}^{∇ MJ} \text{:} \frac{1}{2} ( {e}_{k} ⊗ {e}_{l} + {e}_{l} ⊗ {e}_{k} ) \qquad ( 39 )$$

Note that above equation (39) corresponds to the relationship between the tensor directional derivative and the derivative with respect to ε₂.

Due to the symmetry of C^{∇MJ}, when above equation (39) is expressed as components, following equation (40) is obtained.

$${lim}_{h -> 0} \frac{{τ}_{ij} ( F + h \frac{1}{2} ( {e}_{k} ⊗ {e}_{l} + {e}_{l} ⊗ {e}_{k} ) F ) - {τ}_{ij} ( F )}{h} = {J ( {C}^{∇ MJ} )}_{ijkl} \qquad ( 40 )$$

When the equation of the derivative of the left side of above equation (40) is rewritten by using the multi dual numbers, following equation (41) is obtained.

$${𝒥}_{2} [ {τ}_{ij} ( F + {ɛ}_{2} \frac{1}{2} ( {e}_{k} ⊗ {e}_{l} + {e}_{l} ⊗ {e}_{k} ) F ) ] = {J ( {C}^{∇ MJ} )}_{ijkl} \qquad ( 41 )$$

Note that above equation (41) corresponds to the relational expression between the second physical quantity and the first physical quantity.

Accordingly, by setting

$$Δ {F}_{2}^{( kl )} = \frac{{ɛ}_{2}}{2} ( {e}_{k} ⊗ {e}_{l} + {e}_{l} ⊗ {e}_{k} ) \cdot F$$

it can be understood that the (ijkl)-th component (C^{∇MJ})ᵢⱼₖₗ of C^{∇MJ} is obtained in above equation (18).

Finally, the equations are further contrived so as to be able to simultaneously evaluate above equation (30) and equation (41). Note that above equation (30) corresponds to the relational expression between the first physical quantity and the function W(X).

ΔF₁^{(ij)} is used for computing the stress (the first order derivative of the energy function W), and ΔF₂^{(kl)} is used for computing the material Jacobian (the second order derivative of the energy function W). In consideration thereof, it is natural to set the component of the stress in the coefficient of ε₁ such that the component of the material Jacobian appears in the coefficient of ε₁ε₂. Therefore, when ^{˜}ΔF₂^{(kl)} of above equation (21) is used instead of ΔF₂^{(kl)}, this goal is achieved well. Confirming this will be attempted by actually computing above equation (20) and equation (22).

$$\begin{matrix}\begin{matrix}J ( {C}^{∇ MJ} ) = {𝒥}_{2} [ {τ}_{ij} ( F + {ɛ}_{2} + \frac{1}{2} ( {e}_{k} ⊗ {e}_{l} + {e}_{l} ⊗ {e}_{k} ) F ) ] \\ = {𝒥}_{12} [ W ( \begin{matrix}( F + {ɛ}_{2} \frac{1}{2} ( {e}_{k} ⊗ {e}_{l} + {e}_{l} ⊗ {e}_{k} ) F ) + \\ \begin{matrix}{ɛ}_{1} \frac{1}{2} ( {e}_{i} ⊗ {e}_{j} + {e}_{j} ⊗ {e}_{i} ) \\ ( F + {ɛ}_{2} \frac{1}{2} ( {e}_{k} ⊗ {e}_{l} + {e}_{l} ⊗ {e}_{k} ) F )\end{matrix}\end{matrix} ) ] \\ = {𝒥}_{12} [ W ( \begin{matrix}\begin{matrix}F + {ɛ}_{1} \frac{1}{2} ( {e}_{i} ⊗ {e}_{j} + {e}_{j} ⊗ {e}_{i} ) F + \\ {ɛ}_{2} \frac{1}{2} ( {e}_{k} ⊗ {e}_{l} + {e}_{l} ⊗ {e}_{k} ) F +\end{matrix} \\ {ɛ}_{1} \frac{1}{2} ( {e}_{i} ⊗ {e}_{j} + {e}_{j} ⊗ {e}_{i} ) {ɛ}_{2} \frac{1}{2} ( {e}_{k} ⊗ {e}_{l} + {e}_{l} ⊗ {e}_{k} ) F\end{matrix} ) ] \\ = {𝒥}_{12} [ W ( \begin{matrix}F + Δ {F}_{1}^{( ij )} + Δ {F}_{2}^{( kl )} + \\ {ɛ}_{1} \frac{1}{2} ( {e}_{i} ⊗ {e}_{j} + {e}_{j} ⊗ {e}_{i} ) {F}_{2}^{( kl )}\end{matrix} ) ] \\ = {𝒥}_{12} [ W ( F + Δ {F}_{1}^{( ij )} + Δ {\tilde{F}}_{2}^{( kl )} ) ]\end{matrix} & ( 42 ) \\ \begin{matrix}{𝒥}_{1} [ W ( F + Δ {F}_{1}^{( ij )} + Δ {\tilde{F}}_{2}^{( kl )} ) ] = {𝒥}_{1} [ W ( \begin{matrix}F + Δ {F}_{1}^{( ij )} + Δ {F}_{2}^{( kl )} + \\ {ɛ}_{1} \frac{1}{2} ( {e}_{i} ⊗ {e}_{j} + {e}_{j} ⊗ {e}_{i} ) Δ {F}_{2}^{( kl )}\end{matrix} ) ] \\ = {𝒥}_{1} [ W ( F + Δ {F}_{1}^{( ij )} ) ] \\ = J {σ}_{ij}\end{matrix} & ( 43 )\end{matrix}$$

Above equation (20) is derived as per above equation (42), and above equation (22) is derived as per above equation (43). Note that above equation (42) corresponds to the relational expression between the second physical quantity and the function W(X).

Here, a summary of FEM computation is explained. The finite element method is a method of, in structural analysis and the like, approximating an object, that has infinite degrees of freedom with respect to deformation, as an aggregate of finite elements having finite degrees of freedom, i.e., an aggregate of small portions, and solving simultaneous linear equations that are established for the aggregate. This small portion is called a finite element. A finite element is prescribed as the joining of points called nodes. Any given element is joined to another element by a node. Force also is joined through nodes. No matter how complex the shape of a structural object is, it can be sectioned into finite elements and can be expressed as an aggregate of finite elements. Each finite element has a stiffness matrix expressing the behavior of the material (a tangent stiffness matrix in the case of nonlinear analysis).

Operation at the time of carrying out simulation using the FEM by the information processing device 10 relating to the first embodiment is described next.

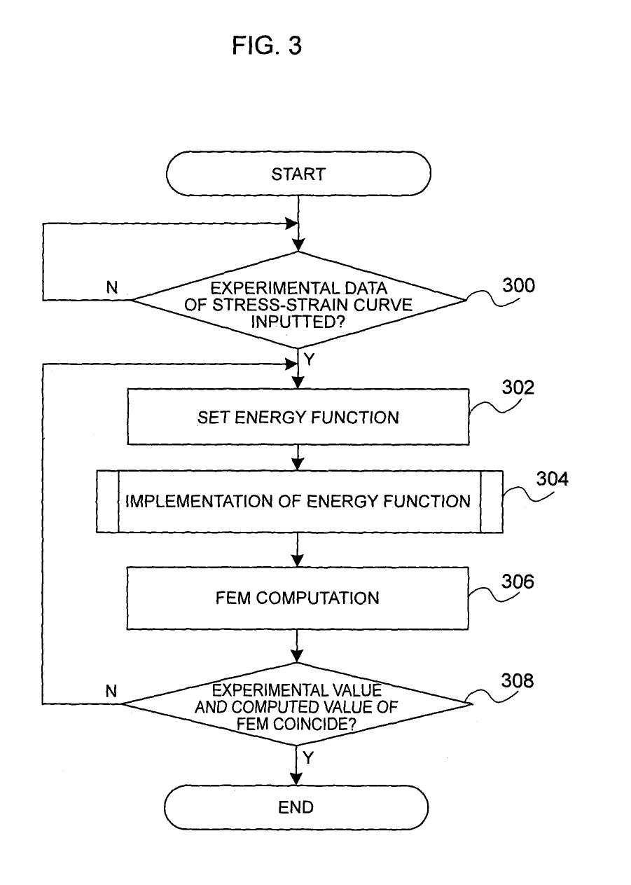

First, plural types of energy functions W(F), that have been proposed in the field of materials science and are to be used in simulation of a material, are inputted to the information processing device 10. Further, the equation of ΔF₁^{(ij)} for deriving the Cauchy stress tensor σ and the equation of ^{˜}ΔF₂^{(kl)} for deriving the material Jacobian C^{∇MJ} are computed in advance from the energy function W(F), and are inputted to the information processing device 10. Then, the simulation processing routine shown in FIG. 3 is executed by the information processing device 10.

First, in step 300, it is judged whether or not experimental data of the stress-strain curve of the material has been inputted to the information processing device 10. When this experimental data is inputted, the routine proceeds to step 302 where the information processing device 10 sets any one of the inputted energy functions as the energy function that is to be used in simulation. Further, the information processing device 10 sets the material parameters that are included in that energy function. For example, the material parameters that are included in that energy function are identified so as to match the experimental data of the stress-strain curve inputted in above step 300.

Then, in step 304, the information processing device 10 carries out processing that implements the energy function, that was set in above step 302, into FEM computation.

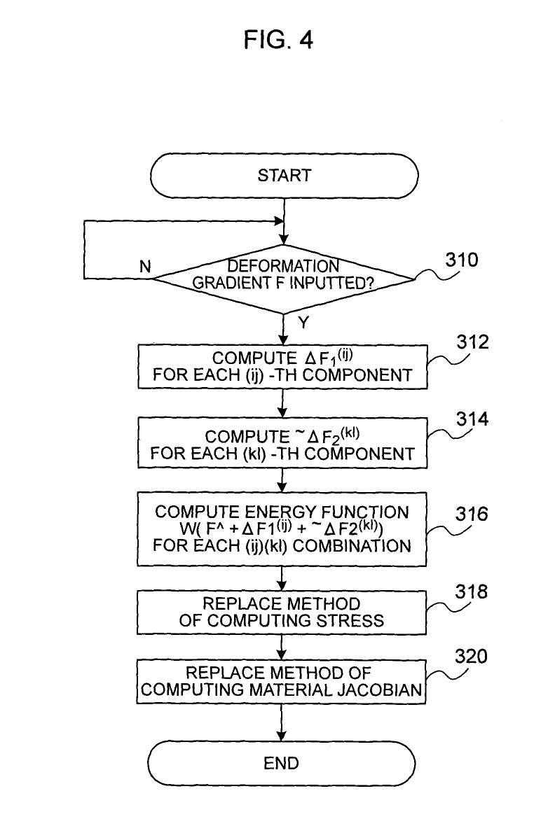

Above step 304 is realized by the processing routine shown in FIG. 4.

In step 310, it is judged whether or not the tensor amount of the strain (the deformation gradient tensor) F̂ has been inputted to the information processing device 10. Then, in step 312, on the basis of the deformation gradient F̂ inputted in above step 310, the information processing device 10 computes, for each component (ij), the equation of ΔF₁^{(ij)} that was inputted and that was set in advance in order to compute the Cauchy stress from the energy function W. At this time, ΔF₁^{(ij)} is computed as per above equation (14) by using ε₁ that is a Multi dual numbers (MDN).

In next step 314, on the basis of the deformation gradient F̂ inputted in above step 310, the information processing device 10 computes, for each component (kl), the equation of ^{˜}ΔF₂^{(kl)} that was inputted and that was set in advance in order to compute the material Jacobian C^{∇MJ} from the energy function W. At this time, ^{˜}ΔF₂^{(kl)} is computed as per above equation (21) by using ε₁, ε₂ that are the MDNs.

Then, in step 316, on the basis of the results of computation of above step 312 and the results of computation of above step 314, the information processing device 10 carries out computation of the energy function W(F̂+ΔF₁^{(ij)}+^{˜}ΔF₂^{(kl)}) for each combination of the (ij)-th component and (kl)-th component.

In next step 318, the information processing device 10 replaces the computation of the component σᵢⱼ of the Cauchy stress in the FEM computation that is described later, with processing that takes-out the coefficient of ε₁ of the energy function W(F̂+ΔF₁^{(ij)}+^{˜}ΔF₂^{(kl)}) computed in above step 316.

Further, in step 320, the information processing device replaces the computation of the component (C^{∇MJ})ᵢⱼₖₗ of the material Jacobian in the FEM computation that is described later, with processing that takes-out the coefficient of ε₁ε₂ of the energy function W(F̂+ΔF₁^{(ij)}+^{˜}ΔF₂^{(kl)}) computed in above step 316, and ends this processing routine.

Due thereto, processing, that automatically computes the stress and the material Jacobian from an energy function expression, can be implemented into the routine of the material constitutive model within the FEM program.

Further, in step 306 of the simulation processing routine, the information processing device 10 computes, by FEM computation and for each integration point, the stress with respect to the deformation gradient tensor F that was inputted in above step 310. At this time, the computational methods that were replaced-in in above steps 318, 320 are used in computing the stress and the material Jacobian.

The flow of the FEM computation is described here. Note that the flow of increment-iteration type nonlinear FEM of load control is described hereinafter.

(1) Divide the object of analysis into finite elements.

(2) Set the boundary conditions.

(3) Compute the element tangent stiffness matrix of each finite element.

(4) Compute the overall tangent stiffness matrix by superimposing and combining the finite tangent stiffness matrices.

(5) Eliminate the components of the overall tangent stiffness matrix that correspond to the constrained degrees of freedom of displacement, and degenerate the overall tangent stiffness matrix.

(6) Provide the load increment.

(7) Solve the simultaneous linear equations and compute the displacement increment.

(8) Add the displacement increment, that was computed in above (7), to the overall displacement amount so as to update the overall displacement amount.

(9) Compute the stress, strain of each finite element from the overall displacement amount.

(10) Compute the equivalent nodal force of each finite element from the stress of each finite element.

(11) Superpose the equivalent nodal forces of the respective finite elements so as to compute the equivalent nodal force of the overall structure.

(12) Compare the equivalent nodal force of the overall structure, that was computed in above (11), and the load increment, that was provided in above (6), and confirm whether the forces are in equilibrium.

(13) If the forces are not in equilibrium, return to above (3), and compute an element tangent stiffness matrix to which the displacement increment computed in above (7) is added.

(14) Repeat above computational steps (3) through (13) until the forces are in equilibrium (this iterative computation is called Newton-Raphson iteration).

(15) When the forces are in equilibrium, add the next load increment, and repeat the computations of above (3) through (15) (this incremental computation is called incrementing).

(16) Continue to increment the load, and when the desired load value is reached, end computation.

(17) Display the overall displacement distribution, load distribution, strain distribution and stress distribution by post-processing.

Further, the method of preparing the element tangent stiffness matrix in above (3) is shown hereinafter.

At the time of computing the element tangent stiffness matrix, integration within the volume of the finite element is required, and numerical integration (Gauss integration, Newton-Cotes integration or the like) is usually used therefor. Namely, a stiffness matrix is computed at plural integration points within the element, and these are weighted and the total sum is obtained. Moreover, in the case of a finite element that requires mapping from general coordinates to natural coordinates, such as an isoparametric quadrilateral element or the like, computation of the Jacobian matrix (the Jacobian) at each integration point is carried out.

(3-1) Determine the integration point coordinates and the weight.

(3-2) For each integration point, determine the Jacobian and the inverse matrix thereof.

(3-3) For each integration point, determine the displacement-strain matrix.

(3-4) For each integration point, determine the stress and the strain.

(3-5) For each integration point, determine the material Jacobian.

(3-6) For each integration point, determine the tangent stiffness matrix.

(3-7) Apply weight to tangent stiffness matrix of each integration point and compute the total sum, and compute the element tangent stiffness matrix.

In the replacement of above step 320, the computational methods in the computing of the stress of above (3-4) and the computing of the material Jacobian in above (3-5) are replaced.

Then, in step 308, the information processing device 10 compares the stress that was computed in above step 306 and, in the experimental data that was inputted in above step 300, the stress with respect to the strain amount F̂ that was inputted in above step 310, and judges whether the experimental value and the computed value of the FEM coincide. If the experimental value and the computed value of the FEM coincide, the information processing device 10 outputs the energy function at this time, and ends the simulation processing routine. On the other hand, if the experimental value and the computed value of the FEM do not coincide, the information processing device 10 returns to above step 302, and sets another energy function as the energy function to be used in simulation.

As described above, the information processing device relating to the first embodiment computes the energy function W(F̂+ΔF₁^{(ij)}+^{˜}ΔF₂^{(kl)}) by using the multi dual numbers, and takes-out the coefficient of ε₁ in the energy function W(F̂+ΔF₁^{(ij)}+^{˜}ΔF₂^{(kl)}) and computes the stress that is based on the first order derivative with respect to the tensor amount F of the energy function W(F), and takes-out the coefficient of ε₁·ε₂ in the energy function W(F̂+ΔF₁^{(ij)}+^{˜}ΔF₂^{(kl)}) and computes the material Jacobian that is based on the second order derivative with respect to the tensor amount F of the energy function W(F). Due thereto, the information processing device can compute the stress and the material Jacobian while suppressing the occurrence of errors.

The new system of numbers that is the multi dual numbers has the property of automatically computing the first order derivative value and the second order derivative value of a function, and further, the multi dual numbers have good affinity with the directional derivative of the tensor. By combining these properties, it is possible to automatically compute both the stress and the material Jacobian from an energy function expression. Conventionally, these computations all had to be derived analytically by manual computation. Therefore, in the case of handling a complex material constitutive model, profoundly specialized knowledge for performing this computation and a large number of processes were needed. By introducing the information processing device relating to the present embodiment, anyone can correctly implement the material constitutive model simply and in a short time. Due thereto, through a user subroutine or the like, an energy function that is proposed in the field of materials science can be implemented in all-purpose finite element method software easily regardless of the complexity of the energy function, and the speed of materials development is greatly improved.

Further, a complex energy function expression can easily be implemented into FEM computation, and comparison with the results of material experimentation, and arbitrary deformation behavior, that has not yet been observed, of a material can be predicted.

Hyperelastic materials, of which polymer elastomers such as rubber and the like are representative examples, have a strain energy density function W. The strain energy density function W is defined as the elastic energy per unit volume that is stored due to deformation of an object. The change in W in an isothermal condition is equivalent to the change in the free energy of the system. Accordingly, if the function form of W is already known, the stress-strain relationship with respect to an arbitrary state of deformation can be determined. In a case in which the FEM is used in order to learn the mechanical responses of an elastomer under complex deformation, the reliability of the results of analysis depend greatly on the function form of W. In the field of polymer physics, many strain energy density functions W that reflect the network structure of elastomers are proposed from molecular theoretical examinations. When using such a strain energy density function W, the mechanical responses of a multi-axis deformation field can be predicted with high accuracy by using experimental data of only a uniaxial tension test in which experimentation is simple. However, the function form of a highly-accurate strain energy density function W tends to become complex, and computing the stress tensor and the material Jacobian from these W is a barrier to implementation into the FEM. If the information processing device relating to the present embodiment is used, the stress tensor and material Jacobian can be computed automatically from W.

Note that the above first embodiment describes, as an example, a case in which an energy function that is used in material simulation is inputted, but the present invention is not limited to this, and other functions that are used in other simulations may be inputted. For example, simulation of the deformation amounts at various stress fields may be carried out on, for example, high polymers, metals, nonferrous metals, semiconductors, ceramics, soil, rheological substances, piezo-electric materials, magnetic materials, superconductive substances, or composite materials in which these are combined, and a function that is to be used in this simulation may be inputted.

The program of the present invention may be provided by being stored in a storage medium.

A computer readable medium that is an aspect of the present invention is a computer readable medium that stores a program for determining directional derivative of a scalar valued function with respect to a tensor by using two numbers ε₁, ε₂ that are imaginary units and each of which squared is 0 and that are defined as numbers that are able to replace one another with regard to multiplication, the program causing a computer to function as: a first perturbation computing section that, for each (ij)-th component of a tensor, computes an equation that is denoted by ΔF₁^{(ij)} and that uses ε₁, on the basis of a function W(F) of an inputted tensor amount F and a value (F=F̂) of the tensor amount F; a second perturbation computing section that, for each (kl)-th component of a tensor, computes a equation that is denoted by ^{˜}ΔF₂^{(kl)} and that uses ε₁ and ε₂, on the basis of the value (F=F̂) of the tensor amount F; a function computing section that, for each combination of an (ij)-th component and a (kl)-th component of a tensor, computes a function W(F̂+ΔF₁^{(ij)}+^{˜}ΔF₂^{(kl)}) by using the computed equation that is denoted by ΔF₁^{(ij)} and the computed equation that is denoted by ^{˜}ΔF₂^{(kl)}; a first physical quantity computing section that, for each (ij)-th component of a tensor, takes-out a coefficient of ε₁ in the function W(F̂+ΔF₁^{(ij)}+^{˜}ΔF₂^{(kl)}) that was computed by the function computing section, and computes a first physical quantity that is based on a first order derivative with respect to the tensor amount F of the function W(F); and a second physical quantity computing section that, for each combination of an (ij)-th component and a (kl)-th component of a tensor, takes-out a coefficient of ε₁·ε₂ in the function W(F̂+ΔF₁^{(ij)}+^{˜ΔF}₂^{(kl)})) that was computed by the function computing section, and computes a second physical quantity that is based on a second order derivative with respect to the tensor amount F of the function W(F), wherein the equation that is denoted by ΔF₁^{(ij)} is determined in advance such that the coefficient of ε₁ in the function W(F̂+ΔF₁^{(ij)}+^{˜}ΔF₂^{(kl)}) becomes the first physical quantity, and the equation denoted by ^{˜}ΔF₂^{(kl)} is determined in advance such that the coefficient of ε₁·ε₂ in the function W(F̂+ΔF₁^{(ij)}+^{˜}ΔF₂^{(kl)}) becomes the second physical quantity.

A computer readable medium that is an aspect of the present invention is a computer readable medium that stores a program for determining directional derivative of a scalar valued function with respect to a tensor that relates to a material that is an object of simulation, by using two numbers ε₁, ε₂ that are imaginary units and each of which squared is 0 and that are defined as being numbers that are able to replace one another with regard to multiplication, the program causing a computer to function as: a first perturbation computing section that, for each (ij)-th component of a tensor, computes a equation that is denoted by ΔF₁^{(ij)} and that uses ε₁, on the basis of a function W(F) of a tensor amount F, that is inputted as a deformation gradient tensor expressing strain, and a value (F=F̂) of the tensor amount F; a second perturbation computing section that, for each (kl)-th component of a tensor, computes a equation that is denoted by ^{˜}ΔF₂^{(kl)} and that uses ε₁ and ε₂, on the basis of the value (F=F̂) of the tensor amount F; a function computing section that, for each combination of an (ij)-th component and a (kl)-th component of a tensor, computes a function W(F̂+ΔF₁^{(ij)}+^{˜}ΔF₂^{(kl)}) by using the computed equation that is denoted by ΔF₁^{(ij)} and the computed equation that is denoted by ^{˜}ΔF₂^{(kl)}; a first physical quantity computing section that, for each (ij)-th component of a tensor, takes-out a coefficient of ε₁ in the function W(F̂+ΔF₁^{(ij)}+^{˜}ΔF₂^{(kl)}) that was computed by the function computing section, and computes a stress tensor that is based on a first order derivative with respect to the tensor amount F of the function W(F); a second physical quantity computing section that, for each combination of an (ij)-th component and a (kl)-th component of a tensor, takes-out a coefficient of ε₁·ε₂ in the function W(F̂+ΔF₁^{(ij)}+^{˜}ΔF₂^{(kl)}) that was computed by the function computing section, and computes a material Jacobian that is based on a second order derivative with respect to the tensor amount F of the function W(F); and a simulation section that carries out simulation that relates to behavior of the material and that uses the finite element method (FEM), by using the stress tensor computed by the first physical quantity computing section and the material Jacobian computed by the second physical quantity computing section, wherein the equation denoted by ΔF₁^{(ij)} is determined in advance such that the coefficient of ε₁ in the function W(F̂+ΔF₁^{(ij)}+^{˜}ΔF₂^{(kl)}) becomes the stress tensor, and the equation denoted by ^{˜}ΔF₂^{(kl)} is determined in advance such that the coefficient of ε₁·ε₂ in the function W(F̂+ΔF₁^{(ij)}+^{˜}ΔF₂₍ₖₗ₎) becomes the material Jacobian.

The disclosure of Japanese Patent Application No. 2012-197851 is, in its entirety, incorporated by reference into the present Description.

All documents, patent applications, and technical standards mentioned in the present Description are incorporated by reference into the present Description to the same extent as if such individual document, patent application, or technical standard was specifically and individually indicated to be incorporated by reference.

1. An information processing device that determines a directional derivative of a scalar valued function with respect to a tensor by using two numbers ε₁, ε₂ that are imaginary units and each of which squared is 0 and that are defined as numbers that are able to replace one another with regard to multiplication, the information processing device comprising:
a first perturbation computing section that, for each (ij)-th component of a tensor, computes an equation that is denoted by ΔF₁^{(ij)} and that uses ε₁, on the basis of a function W(F) of a tensor amount F and a value (F=F̂) of the tensor amount F that are inputted;
a second perturbation computing section that, for each (kl)-th component of a tensor, computes an equation that is denoted by ^{˜}ΔF₂^{(kl)} and that uses ε₁ and ε₂, on the basis of the value (F=F̂) of the tensor amount F;
a function computing section that, for each combination of an (ij)-th component and a (kl)-th component of a tensor, computes a function W(F̂+ΔF₁^{(ij)}+^{˜}ΔF₂^{(kl)}) by using the computed equation that is denoted by ΔF₁^{(ij)} and the computed equation that is denoted by ^{˜}ΔF₂^{(kl)};
a first physical quantity computing section that, for each (ij)-th component of a tensor, takes-out a coefficient of ε₁ in the function W(F̂+ΔF₁^{(ij)}+^{˜}ΔF₂^{(kl)}) that was computed by the function computing section, and computes a first physical quantity that is based on a first order derivative with respect to the tensor amount F of the function W(F); and
a second physical quantity computing section that, for each combination of an (ij)-th component and a (kl)-th component of a tensor, takes-out a coefficient of ε₁·ε₂ in the function W(F̂+ΔF₁^{(ij)}+^{˜}ΔF₂^{(kl)}) that was computed by the function computing section, and computes a second physical quantity that is based on a second order derivative with respect to the tensor amount F of the function W(F),
wherein the equation denoted by ΔF₁^{(ij)} is determined in advance such that the coefficient of ε₁ in the function W(F̂+ΔF₁^{(ij)}+^{˜}ΔF₂^{(kl)}) becomes the first physical quantity, and
the equation denoted by ^{˜}ΔF₂^{(kl)} is determined in advance such that the coefficient of ε₁·ε₂ in the function W(F̂+ΔF₁^{(ij)}+^{˜}ΔF₂^{(kl)}) becomes the second physical quantity.

2. The information processing device of claim 1, wherein
the equation denoted by ΔF₁^{(ij)} is determined in advance on the basis of a relational expression between the first physical quantity and a function W(X), and a relationship between directional derivative of a tensor and a derivative with respect to ε₁, and
the equation denoted by ^{˜}ΔF₂^{(kl)} is a equation that uses ΔF₂ and ε₁, and is determined in advance on the basis of (A) a equation that is denoted by ΔF₂^{(kl)} and that uses ε₂ and is determined on the basis of a relational expression between an increment of the first physical quantity and the second physical quantity, and a relationship between the directional derivative of the tensor and a derivative with respect to ε₂, and (B) a relational expression between the second physical quantity and the function W(X) which relational expression is obtained from (a) a relational expression between the second physical quantity and the first physical quantity, and (b) a relational expression between the first physical quantity and the function W(X).

3. The information processing device of claim 1, wherein
the function is a function relating to an object of simulation,
the first physical quantity computing section computes the first physical quantity that is to be used in simulation, and
the second physical quantity computing section computes the second physical quantity that is to be used in simulation.

4. The information processing device of claim 3, further comprising a simulation section that carries out simulation using a finite element method (FEM), wherein
the inputted tensor amount is a deformation gradient tensor that expresses strain,
the simulation is a simulation relating to behavior of a material,
the first physical quantity computing section computes a stress tensor as the first physical quantity,
the second physical quantity computing section computes a material Jacobian as the second physical quantity, and
the simulation section carries out simulation by using the stress tensor computed by the first physical quantity computing section and the material Jacobian computed by the second physical quantity computing section.

5. A computer readable medium storing a program causing a computer to execute a process for determining a derivative of a scalar valued function with respect to a tensor by using two numbers ε₁, ε₂ that are imaginary units and each of which squared is 0 and that are defined as numbers that are able to replace one another with regard to multiplication, the process comprising:
by a first perturbation computing section, for each (ij)-th component of a tensor, computing an equation that is denoted by ΔF₁^{(ij)} and that uses ε₁, on the basis of a function W(F) of a tensor amount F and a value (F=F̂) of the tensor amount F that are inputted;
by a second perturbation computing section, for each (kl)-th component of a tensor, computing an equation that is denoted by ^{˜}ΔF₂^{(kl)} and that uses ε₁ and ε₂, on the basis of the value (F=F̂) of the tensor amount F;
by a function computing section, for each combination of an (ij)-th component and a (kl)-th component of a tensor, computing a function W(F̂+ΔF₁^{(ij)}+^{˜}ΔF₂^{kl)}) by using the computed equation that is denoted by ΔF₁^{(ij)} and the computed equation that is denoted by ^{˜}ΔF₂^{(kl)};
by a first physical quantity computing section, for each (ij)-th component of a tensor, taking-out a coefficient of ε₁ in the function W(F̂+ΔF₁^{(ij)}+^{˜}ΔF₂^{(kl)}) that was computed by the function computing section, and computing a first physical quantity that is based on a first order derivative with respect to the tensor amount F of the function W(F); and
by a second physical quantity computing section, for each combination of an (ij)-th component and a (kl)-th component of a tensor, taking-out a coefficient of ε₁·ε₂ in the function W(F̂+ΔF₁^{(ij)}+^{˜}ΔF₂^{(kl)}) that was computed by the function computing section, and computing a second physical quantity that is based on a second order derivative with respect to the tensor amount F of the function W(F),
wherein the equation denoted by ΔF₁^{(ij)} is determined in advance such that the coefficient of ε₁ in the function W(F̂+ΔF₁^{(ij)}+^{˜}ΔF₂^{(kl)}) becomes the first physical quantity, and
the equation denoted by ^{˜}ΔF₂^{(kl)} is determined in advance such that the coefficient of ε₁·ε₂ in the function W(F̂+ΔF₁^{(ij)}+^{˜}ΔF₂^{(kl)} becomes the second physical quantity.

6. An information processing device that determines a directional derivative of a scalar valued function with respect to a tensor that relates to a material that is an object of simulation, by using two numbers ε₁, ε₂ that are imaginary units and each of which squared is 0 and that are defined as numbers that are able to replace one another with regard to multiplication, the information processing device comprising:
a first perturbation computing section that, for each (ij)-th component of a tensor, computes an equation that is denoted by ΔF₁^{(ij)} and that uses ε₁, on the basis of an inputted function W(F) of a tensor amount F, and a value (F=F̂) of the tensor amount F that is inputted as a deformation gradient tensor expressing strain;
a second increment amount computing section that, for each (kl)-th component of a tensor, computes an equation that is denoted by ^{˜}ΔF₂^{(kl)} and that uses ε₁ and ε₂, on the basis of the value (F=F̂) of the tensor amount F;
a function computing section that, for each combination of an (ij)-th component and a (kl)-th component of a tensor, computes a function W(F̂+ΔF₁^{(ij)}+^{˜}ΔF₂^{(kl)}) by using the computed equation that is denoted by ΔF₁^{(ij)} and the computed equation that is denoted by ^{˜}ΔF₂^{(kl)};
a first physical quantity computing section that, for each (ij)-th component of a tensor, takes-out a coefficient of ε₁ in the function W(F̂+ΔF₁^{(ij)}+^{˜}ΔF₂^{(kl)}) that was computed by the function computing section, and computes a stress tensor that is based on a first order derivative with respect to the tensor amount F of the function W(F);
a second physical quantity computing section that, for each combination of an (ij)-th component and a (kl)-th component of a tensor, takes-out a coefficient of ε₁·ε₂ in the function W(F̂+ΔF₁^{(ij)}+^{˜}ΔF₂^{(kl)}) that was computed by the function computing section, and computes a material Jacobian that is based on a second order derivative with respect to the tensor amount F of the function W(F); and
a simulation section that carries out simulation that relates to behavior of the material and that uses a finite element method (FEM), by using the stress tensor computed by the first physical quantity computing section and the material Jacobian computed by the second physical quantity computing section,
wherein the equation denoted by ΔF₁^{(ij)}is determined in advance such that the coefficient of ε₁ in the function W(F̂+ΔF₁^{(ij)}+^{˜}ΔF₂^{(kl)} becomes the stress tensor, and
the equation denoted by ^{˜}ΔF₂^{(kl)} is determined in advance such that the coefficient of ε₁·ε₂ in the function W(F̂+ΔF₁^{(ij)}+^{˜}ΔF₂^{(kl)} becomes the material Jacobian.

7. A computer readable medium storing a program causing a computer to execute a process for determining a directional derivative of a scalar valued function with respect to a tensor that relates to a material that is an object of simulation, by using two numbers ε₁, ε₂ that are imaginary units and each of which squared is 0 and that are defined as being numbers that are able to replace one another with regard to multiplication, the process comprising:
by a first perturbation computing section, for each (ij)-th component of a tensor, computing an equation that is denoted by ΔF₁^{(ij)} and that uses ε₁, on the basis of an inputted function W(F) of a tensor amount F, and a value (F=F̂) of the tensor amount F that is inputted as a deformation gradient tensor expressing strain,
by a second perturbation computing section, for each (kl)-th component of a tensor, computing an equation that is denoted by ^{˜}ΔF₂^{(kl)} and that uses ε₁ and ε₂, on the basis of the value (F=F̂) of the tensor amount F;
by a function computing section, for each combination of an (ij)-th component and a (kl)-th component of a tensor, computing a function W(F̂+ΔF₁^{(ij)}+^{˜}ΔF₂^{(kl)}) by using the computed equation that is denoted by ΔF₁^{(ij)} and the computed equation that is denoted by ^{˜}ΔF₂^{(kl)};
by a first physical quantity computing section, for each (ij)-th component of a tensor, taking-out a coefficient of ε₁ in the function W(F̂+ΔF₁^{(ij)}+^{˜}ΔF₂^{(kl)}) that was computed by the function computing section, and computing a stress tensor that is based on a first order derivative with respect to the tensor amount F of the function W(F);
by a second physical quantity computing section, for each combination of an (ij)-th component and a (kl)-th component of a tensor, taking-out a coefficient of ε₁·ε₂ in the function W(F̂+ΔF₁^{(ij)}+^{˜}ΔF₂^{(kl)}) that was computed by the function computing section, and computing a material Jacobian that is based on a second order derivative with respect to the tensor amount F of the function W(F); and
by a simulation section carrying out simulation that relates to behavior of the material and using a finite element method (FEM), by using the stress tensor computed by the first physical quantity computing section and the material Jacobian computed by the second physical quantity computing section,
wherein the equation denoted by ΔF₁^{(ij)} is determined in advance such that the coefficient of ε₁ in the function W(F̂+ΔF₁^{(ij)}+^{˜}ΔF₂^{(kl)}) becomes the stress tensor, and
the equation denoted by ^{˜}ΔF₂^{(kl)} is determined in advance such that the coefficient of ε₁·ε₂ in the function W(F̂+ΔF₁^{(ij)}+^{˜}ΔF₂^{(kl)}) becomes the material Jacobian.

8. An information processing method that determines a directional derivative of a scalar valued function with respect to a tensor by using two numbers ε₁, ε₂ that are imaginary units and each of which squared is 0 and that are defined as numbers that are able to replace one another with regard to multiplication, the information processing method comprising:
for each (ij)-th component of a tensor, computing, by a first perturbation computing section, an equation that is denoted by ΔF₁^{(ij)} and that uses ε₁, on the basis of a function W(F) of an tensor amount F and a value (F=F̂) of the tensor amount F that are inputted;
for each (kl)-th component of a tensor, computing, by a second perturbation computing section, an equation that is denoted by ^{˜}ΔF₂^{(kl)} and that uses ε₁ and ε₂, on the basis of the value (F=F̂) of the tensor amount F;
for each combination of an (ij)-th component and a (kl)-th component of a tensor, computing, by a function computing section, a function W(F̂+ΔF₁^{(ij)}+^{˜}ΔF₂^{(kl)}) by using the computed equation that is denoted by ΔF₁^{(ij)} and the computed equation that is denoted by ^{˜}ΔF₂^{(kl)};
by a first physical quantity computing section and for each (ij)-th component of a tensor, taking-out a coefficient of ε₁ in the function W(F̂+ΔF₁^{(ij)}+^{˜}ΔF₂^{(kl)}) that was computed by the function computing section, and computing a first physical quantity that is based on a first order derivative with respect to the tensor amount F of the function W(F); and
by a second physical quantity computing section and for each combination of an (ij)-th component and a (kl)-th component of a tensor, taking-out a coefficient of ε₁·ε₂ in the function W(F̂+ΔF₁^{(ij)}+^{˜}ΔF₂^{(kl)}) that was computed by the function computing section, and computing a second physical quantity that is based on a second order derivative with respect to the tensor amount F of the function W(F),
wherein the equation denoted by ΔF₁^{(ij)} is determined in advance such that the coefficient of ε₁ in the function W(F̂+ΔF₁^{(ij)}+^{˜}ΔF₂^{(kl)}) becomes the first physical quantity, and
the equation denoted by ^{˜}ΔF₂^{(kl)} is determined in advance such that the coefficient of ε₁·ε₂ in the function W(F̂+ΔF₁^{(ij)}+^{˜}ΔF₂^{(kl)}) becomes the second physical quantity.

9. An information processing method that determines a directional derivative of a scalar valued function with respect to a tensor that relates to a material that is an object of simulation, by using two numbers ε₁, ε₂ that are imaginary units and each of which squared is 0 and that are defined as numbers that are able to replace one another with regard to multiplication, the information processing method comprising:
for each (ij)-th component of a tensor, computing, by a first perturbation computing section, an equation that is denoted by ΔF₁^{(ij)} and that uses ε₁, on the basis of an inputted function W(F) of a tensor amount F, and a value (F=F̂) of the tensor amount F that is inputted as a deformation gradient tensor expressing strain;
for each (kl)-th component of a tensor, computing, by a second perturbation computing section, an equation that is denoted by ^{˜}ΔF₂^{(kl)} and that uses ε₁ and ε₂, on the basis of the value (F=F̂) of the tensor amount F;
for each combination of an (ij)-th component and a (kl)-th component of a tensor, computing, by a function computing section, a function W(F̂+ΔF₁^{(ij)}+^{˜}ΔF₂^{(kl)}) by using the computed equation that is denoted by ΔF₁^{(ij)} and the computed equation that is denoted by ^{˜}ΔF₂^{(kl)};
for each (ij)-th component of a tensor and by a first physical quantity computing section, taking-out a coefficient of ε₁ in the function W(F̂+ΔF₁^{(ij)}+^{˜}ΔF₂^{(kl)}) that was computed by the function computing section, and computing a stress tensor that is based on a first order derivative with respect to the tensor amount F of the function W(F);
for each combination of an (ij)-th component and a (kl)-th component of a tensor and by a second physical quantity computing section, taking-out a coefficient of ε₁·ε₂ in the function W(F̂+ΔF₁^{(ij)}+^{˜}ΔF₂^{(kl)}) that was computed by the function computing section, and computing a material Jacobian that is based on a second order derivative with respect to the tensor amount F of the function W(F); and
by a simulation section, carrying out simulation that relates to behavior of the material and that uses a finite element method (FEM), by using the stress tensor computed by the first physical quantity computing section and the material Jacobian computed by the second physical quantity computing section,
wherein the equation denoted by ΔF₁^{(ij)} is determined in advance such that the coefficient of ε₁ in the function W(F̂+ΔF₁^{(ij)}+^{˜}ΔF₂^{(kl)}) becomes the stress tensor, and
the equation denoted by ^{˜}ΔF₂^{(kl)} is determined in advance such that the coefficient of ε₁·ε₂ in the function W(F̂+ΔF₁^{(ij)}+^{˜}ΔF₂^{(kl)}) becomes the material Jacobian.
